(19) United States
(12) Patent Application Publication
(10) Pub. No.: US 2008/0198771 A1
(43) Pub. Date: Aug. 21, 2008

(54) Method, Apparatus or Software for a Multicast Network for Providing Indications of Active Multicast Groups to one or more Multicast Receivers

(76) Inventor: Ranganath Gorur IYENGAR, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/954,250

(22) Filed: Dec. 12, 2007

(30) Foreign Application Priority Data
Feb. 21, 2007 (IN) 348/CHE/2007

(51) Int. Cl. H04L 12/16

(52) U.S. Cl. 370/270; 370/390

(57) ABSTRACT

A method, apparatus and software is disclosed for enabling data receivers in a multicast network to access data indicating active multicast groups that may be joined.

### BACKGROUND OF THE INVENTION

Multicasting is a method for simultaneously delivering data over a network from one or more data sources to a number of data receivers. Multicasting systems employ routing protocols to link the data sources to the appropriate data receivers in an efficient manner. Multicasting is commonly used to distribute data over Internet Protocol (IP) networks, which may be referred to as IP Multicasting.

IP multicasting networks are provided by multicast enabled nodes within or connected to an existing IP network. The nodes comprise multicast sources, multicast receivers and multicast routers. The multicast sources are the source of the multicast data that is carried via the IP network to the multicast receivers. The multicast routers are arranged to route the multicast data packets across the IP network between the multicast sources and receivers.

Two tasks are necessary for the implementation of a multicast network. Firstly, the membership of a set of receivers needs to be managed. This group management may be performed manually by network administrators. Alternatively, a multicasting group management protocol may be implemented on a network nodes that connect receivers, to enable the automatic management of the multicast group joining process for receivers. An example of a group management protocol is the Internet Group Management Protocol (IGMP).

Secondly, the routing of the multicast data multicast packets over the IP network must be managed. Such routing may be configured manually by network administrators. Alternatively, a multicasting routing protocol may be implemented on each node in the IP network to enable the automatic creation of optimal routing trees between the multicast sources and receivers. Examples of such a routing protocols are provided by a group of protocols referred to as Protocol Independent Multicast (PIM) protocols. A commonly used example of PIM protocols is PIM-Sparse Mode (PIM-SM). The IGMP and PIM protocols are implemented generally in accordance with standards defined by the Internet Engineering Task Force (IETF).

The nodes within a multicast network that are enabled with the PIM-SM and IGMP protocols are effectively self-organising in terms of routing and group membership management. The core router in a PIM-SM protocol enabled network is referred to as a Rendezvous Point (RP). The routers, which provide the connection points for multicast sources or receivers to the multicast network, are referred to as Designated Routers (DRs). The RPs and DRs may be manually specified or automatically selected by the PIM-SM protocol. Normally, one RP is provided for each multicast group. The multicast data is unicast between the source and the RP and then multicast to the relevant receivers from the RP. The multicast connection from the source to the RP is initiated by a source wishing to transmit data over a multicast group. The multicast connection, from the RP to the receivers, is initiated by each receiver that wishes to join an existing multicast group.

The multicast group over which the multicast source will transmit the data is preconfigured on the multicast source application program. Multicast receivers, in the form of media player application programs, receive the data by connecting to a known multicast group IP address. Given the group address, receivers may send an IGMP request, via their associated DRs, to join the group. A feature of the PIM and IGMP protocols is that the organisation of the multicast network is transparent both the multicast sources and receivers.

As noted above, the joining of a multicast group and the construction of the routing tree between receivers and the RP is initiated or driven by the receivers.

However, unless a user of a multicast receiver application program knows the multicast group address or Universal Resource Locator (URL) of a group they wish to join, they are unable to instruct the receiver application program to join a given group.

### BRIEF DESCRIPTION OF THE DRAWINGS

Embodiments of the invention will now be described, by way of example only, with reference to the accompanying drawings in which:

FIG. 1 is a schematic illustration of a multicast network;

FIG. 2 is a table illustrating data used by a router in the network of FIG. 1;

FIGS. 3 is a flow chart illustrating processing carried out by a multicast receiver in the network of FIG. 1; and

FIGS. 4 is a flow chart illustrating processing carried out by a multicast router in the network of FIG. 1.

### DETAILED DESCRIPTION OF PREFERRED EMBODIMENTS OF THE INVENTION

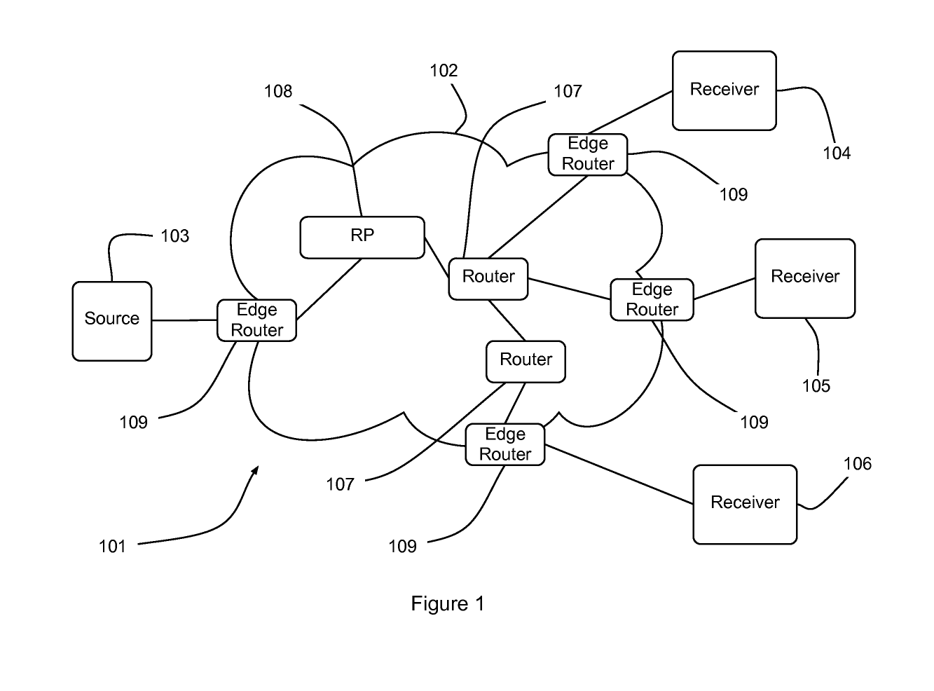

With reference to FIG. 1, a multicast network 101 comprises an IP network 102 connecting a multicast sources 103, in the form of a first computer running a video streaming server application program, to three multicast receivers 104, 105, 106 in the form of media player application programs running on personal computers (PCs). Together, the multicast source and receivers comprise a multicast group. The management of the multicast network 101 is performed by a network element 108 in the form of a router that provides a Rendezvous Point (RP). The IP network 102 further comprises routers 107, 108, 109, each enabled with both the PIM-SM and IGMP protocols. The routers 107, 108, 109 are each running multicasting management programs, which operate in accordance with the PIM-SM and IGMP protocols. In accordance with these protocols, the routers 107, 108, 109 have self-organised to provide a multicasting network between the source 103 and the receivers 104, 105, 106. In doing so, one of the routers has been designated as the Rendezvous Point (RP) 108 and four others of the routers have been designated as Designated Routers (DRs) 109.

When the multicast source 103 is activated, it starts sending data to the preconfigured multicast group IP address with an initiation request to its associated DR 109. In response to this request, the RP 108 receives the multicast data and forwards it to the receivers 104, 105, 106, provided the receivers are active. If none of the receivers 104, 105, 106 are active, the RP 108 instructs the DR 109 to stop sending the multicast data until it requests the source DR 109 to resume doing so. This process is transparently handled by the PIM-SM protocol.

Given the group IP address, the multicast receivers 104, 105, 106 join the multicast group by sending IGMP join requests via their associated DRs 109. These join requests are forwarded automatically by the routers 107, 109 to the RP 108. As each receiver 105, 106, 107 joins the multicast group, the relevant routers 107, 108, 109 build a routing tree from each receiver 104, 105, 106 to the RP 108. The multicast data from the multicast source 103 is then unicast from the source 103 to the RP 108 and multicast, via the established routing tree, to each of the receivers 104, 105, 106. Only one multicast group is shown in FIG. 1, however, a number of additional groups may be set up over the same IP network 102. Each such additional group may use one or more of the same routers 107, 108, 109, any one of which may be designated as the RP for any given additional group.

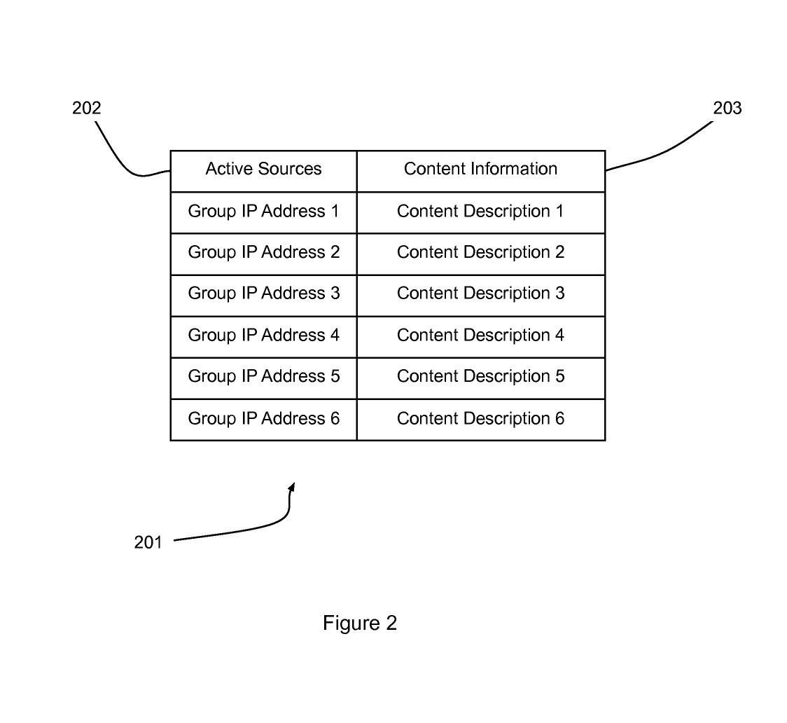

In the present embodiment, the IGMP protocol is extended to enable any of the receivers 104, 105, 106 to establish the group addresses of any active multicast groups on the IP network 102. In response to this active multicast group (AMG) query made to the DR 109, the receiver is provided with a set of active group data 201 as shown in FIG. 2. The active group data 201 comprises the multicast group IP addresses 202 of each active group, received from the corresponding RP for each active group. In addition, the active group data 201 comprises content information 203 for each active multicast group. The content information 203 is arranged to identify the content of the multicast data transmitted for a given group. The content information 203 may be in the form of a URL where content description may be accessed. The content information may be omitted by a multicast source. The list of active multicast group data 201 enables the user of the multicast receiver to identify, select and request to join any one or more of the active groups detailed in the active group data 201.

In the present embodiment, in response to an AMG query initiated from any of the receivers 104, 105, 106, the associated DR 109 forwards the AMG query to each currently designated RP 108. In response to an AMG query, each RP 108 is arranged to respond with the multicast group IP address with which it is operating. If supplied from the multicast source, the RP may also supply the content information 203 in its response to the AMG query. Each response received by the originating receiver program, via the associated DR 109, is displayed to the user as shown in FIG. 2. The user may then select a group from the displayed set 201 and request to join that selected group.

Thus each of the media player application programs providing the receivers 104, 105, 106, is arranged to enable a user to query all of the RPs in the network, via the DR 109, to identify active multicast groups. In response to such a query, the user is provided with a selectable list of the group IP addresses or URLs of the active groups. Where the multicast source has provided content information or a reference to such information, this is also provided to the user to aid the selection or identification of a given group. In response to the user selecting one or more of the active groups, the media player application program is arranged to join the or each selected group using the IGMP protocol as described above and thus receive the appropriate multicast data.

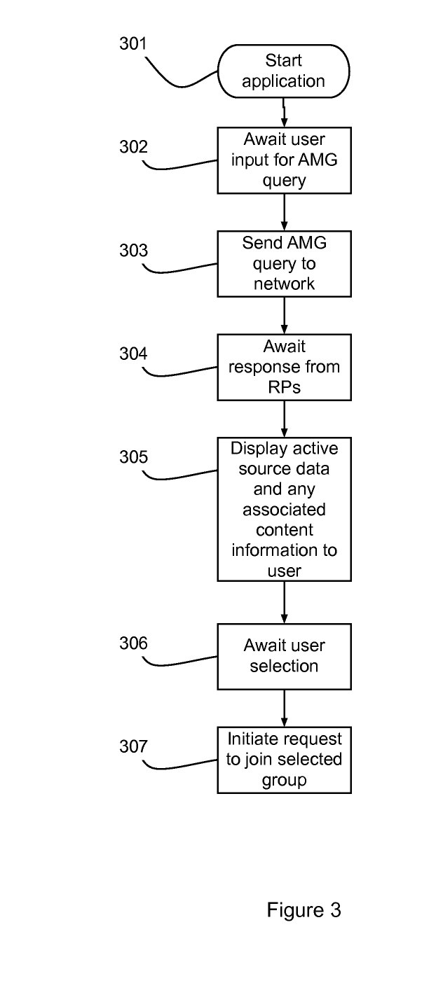

The processing carried out by the media player application program when performing an active group query will now be described further with reference to the flow chart of FIG. 3. At step 301, the media player application program is started up and processing moves to step 302 where selection by the user of an active group query from the program interface is awaited. When an active group query is selected by the user processing moves to step 303 where an active group query is sent to the multicast network via the associated DR 109 and routed automatically to all of the RPs 108 in the network. Processing then moves to step 304 where any response from the RPs 108 is awaited. As each response is received from an RP 108, processing moves to step 305 where the active group data supplied by the RPs 108 is displayed to the user in conjunction with any available content information for each such group. After a predetermined timeout period allowing for all responses to the AMG query to be received, processing then moves to step 306 to await user selection of one or more of the active groups. In response to such user selection, processing moves to step 307 where the joining of the selected group is initiated via the IGMP protocol and processing ends.

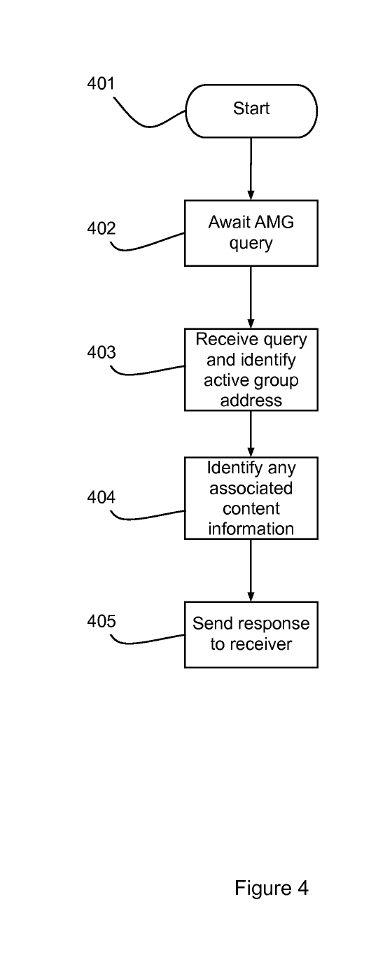

The processing carried out by the multicasting management program running on the RP 108 when responding to an AMG query from a media player application program will now be described further with reference to the flow chart of FIG. 4. At step 401, the RP 108 is initiated and processing moves to step 402. At step 402 the normal processing performed by the multicasting management program continues. When an AMG query is received from a multicast receiver, processing moves to step 403 where, if the current group remains active, processing moves to step 404. At step 404, any content data associated with the active group is also identified. Processing then moves to step 405 where the active group address 202 and any associated content data 203 is sent to the querying multicast receiver and processing ends.

In another embodiment, the data on active multicast groups is collected by an intermediary element, in the form of active channel server (ACS). The ACS is arranged to periodically identify all of the RPs on an attached IP network and to record their active multicast groups and any additional content information they may have. In this embodiment, AMG queries are arranged to be automatically routed to the ACS. The ACS responds to the AMG queries by providing its collected list of active multicast groups to the querying multicast receiver. The ACS may be provided by an existing network management system, such as that provided by the HP Openview™ IT Management System provided by the Hewlett-Packard Development Company, L.P, USA. The identification of the RPs and the collection of the data from active groups may be collected via the Simple Network Management Protocol (SNMP).

In a further embodiment, the ACS is accessed via a protocol other than an extension to the IGMP. For example, the ACS may be accessed directly by the multicast receiver via a URL or IP address. In another embodiment, the ACS is arranged to automatically retrieve relevant content data from a source other than the RP, for example, by querying the multicast source directly. In another embodiment, the list of active groups, collected by the ACS, may be accessed via a web page listing. In a further embodiment, each RP may be arranged to automatically notify its active group to the ACS. The ACS may be arranged for access by multicast routers.

In another embodiment, no content information is logged or provided to the multicast receiver. In a further embodiment the AMG query mechanism is provided as an extension to any suitable multicast management protocol. In another embodiment, the multicast source is queried by the RP for the content data 203 in response to each AMG query, thus removing the need for the RP to maintain such data. In a further embodiment, the multicast network uses the PIM Sparse Mode (PIM-SM) protocol, PIM Source Specific Multicast (PIM-SSM) protocol or the PIM Bi-directional (PIM-Bidir) protocol. In another embodiment, the receiver is arranged to automatically issue the AMG query. The AMG query may be issued at start-up of the receiver or periodically during its operation so as to constantly refresh the active group data.

Enabling a multicast receiver to access a list of active groups relieves the multicast source or group administrators of informing all possible receivers of the existence and possibly the content of any given multicast. Furthermore, the services of third party electronic programming guides (EPGs) or similar services are not required nor is a user required to know a group address before joining that group. Effectively the arrangement described above provided the multicast receivers with an automatic tuning system for multicasts.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for use in a multicast network for providing indications of active multicast groups to one or more multicast receivers, said method comprising the steps of:
a) sending a request to a multicast network for an indication of active multicast groups in said multicast network; and
b) receiving identifications of one or more active multicast groups;
c) selecting one or more of said identified multicast groups; and
d) initiating a join request to said multicast network for the or each selected multicast group.

2. A method according to claim 1 in which said request is arranged to be forwarded to each Rendezvous Point (RP) in the multicast network.

3. A method according to claim 2 in which each said identification of an active multicast group is provided by a respective RP in response to said request.

4. A method according to claim 1 in which each said identification comprises a active multicast group address.

5. A method according to claim 1 in which said identification comprises content data describing the content of the data for said multicast group.

6. A method according to claim 5 in which said content data comprises a reference to the location of information describing the content of said data.

7. A method according to claim 5 in which said content data is received from the multicast source for said data.

8. A method according to claim 1 in which said request is arranged to be provided to an active group server (AGS), said AGS being arranged to identify active groups in said multicast network by querying each respective Rendezvous Point (RP) in the multicast network so as to provide said identification of said one or more active multicast groups to in response to said request.

9. Apparatus for use in a multicast network for providing indications of active multicast groups to one or more multicast receivers, said apparatus being operable to:
send a request to a multicast network for an indication of active multicast groups in said multicast network; and
receive identifications of one or more active multicast groups;
select one or more of said identified multicast groups; and
initiate a join request to said multicast network for the or each selected multicast group.

10. Apparatus according to claim 9 in which said request is arranged to be forwarded to each Rendezvous Point (RP) in the multicast network.

11. Apparatus according to claim 10 in which each said identification of an active multicast group is provided by a respective RP in response to said request.

12. Apparatus according to claim 9 in which each said identification comprises a active multicast group address.

13. Apparatus according to claim 9 in which said identification comprises content data describing the content of the data for said multicast group.

14. Apparatus according to claim 13 in which said content data comprises a reference to the location of information describing the content of said data.

15. Apparatus according to claim 13 in which said content data is received from the multicast source for said data.

16. Apparatus according to claim 9 in which said request is arranged to be provided to an active group server (AGS), said AGS being arranged to identify active groups in said multicast network by querying each respective Rendezvous Point (RP) in the multicast network so as to provide said identification of said one or more active multicast groups to in response to said request.

17. A program or a group of programs arranged to enable a programmable device or group of such devices to carry out the method of claim 1.

18. A program or a group of programs arranged to enable a programmable device or group of such devices to provide the apparatus of claim 9.
